(19) United States
(12) Patent Application Publication
(10) Pub. No.: US 2026/0220239 A1
(43) Pub. Date: Jul. 30, 2026

(54) INFORMATION PROCESSING SYSTEM, AND INFORMATION PROCESSING METHOD

(71) Applicant: NEC Corporation, Tokyo (JP)

(72) Inventors: Masato SASAKI, Tokyo (JP); Ryoma OAMI, Tokyo (JP); Yuka OGINO, Tokyo (JP); Ryo YAMAKABE, Tokyo (JP); Misao SHIINA, Tokyo (JP); Masahiko OSAKA, Tokyo (JP); Megumi KIMURA, Tokyo (JP)

(73) Assignee: NEC Corporation, Tokyo (JP)

(21) Appl. No.: 19/148,718

(22) PCT Filed: Mar. 23, 2023
(86) PCT No.: PCT/JP2023/011527

§ 371 Date: Jul. 17, 2025

(51) Int. Cl. G06F 21/32

(52) U.S. Cl. CPC G06F 21/32

(57) ABSTRACT

An information processing system includes: a biometric information acquisition unit that acquires biometric information from a target moving in a predetermined area, a movement speed acquisition unit that acquires a movement speed of the target, a first output unit that outputs a first guidance information for changing the movement speed of the target, based on the movement speed of the target, and an authentication unit that authenticates the target using the biometric information of the target. According to such an information processing apparatus, it is possible to perform biometric authentication appropriately even in a case where the target is moving.

### TECHNICAL FIELD

The present disclosure relates to technical fields of an information processing system, an information processing method, and a recording medium.

### BACKGROUND ART

A technology is known for outputting guidance information to a target when performing biometric authentication. For example, Patent Literature 1 discloses a technology for guiding a stationary target so that the angle of the target's head is in a suitable state for capturing an iris image. Patent Literature 2 discloses a technology for guiding a target by predicting the blink duration of the target and the time required to reach the focus point when capturing an iris image.

### CITATION LIST

### Patent Literature

Patent Literature 1: International Publication No. WO2021/245823
Patent Literature 2: International Publication No. WO2020/170894

### SUMMARY

### Technical Problem

The present disclosure aims to improve the techniques/technologies disclosed in Citation List.

### Solution to Problem

An information processing system according to an example aspect of the present disclosure includes: a biometric information acquisition unit that acquires biometric information from a target moving in a predetermined area; a movement speed acquisition unit that acquires a movement speed of the target; a first output unit that outputs a first guidance information for changing the movement speed of the target, based on the movement speed of the target; and an authentication unit that authenticates the target using the biometric information of the target.

An information processing system according to another example aspect of the present disclosure includes: a target image acquisition unit that captures a target moving in a predetermined area and acquires a plurality of target images containing biometric information of the target; a sway estimation unit that estimates movement sway caused by a movement of the target in the target image, based on the target image; a second output unit that outputs a second guidance information for changing the movement sway of the target, based on the movement sway of the target; and an authentication unit that authenticates the target using the biometric information of the target.

An information processing method according to an example aspect of the present disclosure is an information processing method that is executed by at least one computer, the information processing method including: acquiring biometric information from a target moving in a predetermined area; acquiring a movement speed of the target; outputting a first guidance information for changing the movement speed of the target, based on the movement speed of the target; and authenticating the target using the biometric information of the target.

An information processing method according to another example aspect of the present disclosure is an information processing method that is executed by at least one computer, the information processing method including: capturing a target moving in a predetermined area and acquiring a plurality of target images containing biometric information of the target; estimating movement sway caused by a movement of the target in the target image, based on the target image; outputting a second guidance information for changing the movement sway of the target, based on the movement sway of the target; and authenticating the target using the biometric information of the target.

A recording medium according to an example aspect of the present disclosure is a recording medium on which a computer program that allows at least one computer to execute an information processing method is recorded, the information processing method including: acquiring biometric information from a target moving in a predetermined area; acquiring a movement speed of the target; outputting a first guidance information for changing the movement speed of the target, based on the movement speed of the target; and authenticating the target using the biometric information of the target.

A recording medium according to another example aspect of the present disclosure is a recording medium on which a computer program that allows at least one computer to execute an information processing method is recorded, the information processing method including: capturing a target moving in a predetermined area and acquiring a plurality of target images containing biometric information of the target; estimating movement sway caused by a movement of the target in the target image, based on the target image; outputting a second guidance information for changing the movement sway of the target, based on the movement sway of the target; and authenticating the target using the biometric information of the target.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a flowchart illustrating a flow of operation of the information processing system according to the second example embodiment.

FIG. 5 is a side view illustrating a gate configuration to which the information processing system according to the third example embodiment is applied.

FIG. 6 is a flowchart illustrating a flow of operation of the information processing system according to the third example embodiment.

FIG. 7 is a side view illustrating a gate configuration to which the information processing system according to the fourth example embodiment is applied.

FIG. 8 is a flowchart illustrating a flow of operation of the information processing system according to the fourth example embodiment.

FIG. 9 is a block diagram illustrating a functional configuration of the information processing system according to the fifth example embodiment.

FIG. 10 is a flowchart illustrating a flow of operation of the information processing system according to the fifth example embodiment.

FIG. 11 is a flowchart illustrating a flow of operation of the information processing system according to the sixth example embodiment.

FIG. 12 is a flowchart illustrating a flow of operation of the information processing system according to the seventh example embodiment.

FIG. 13 is a table illustrating an example of output of second guidance information in the information processing system according to the seventh embodiment.

FIG. 14 is a flowchart illustrating a flow of operation of the information processing system according to the eighth example embodiment.

FIG. 15 is a plan view illustrating an example of an object displayed by the information processing system according to the eighth example embodiment.

FIG. 16 is a flowchart illustrating a flow of operation of the information processing system according to the ninth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

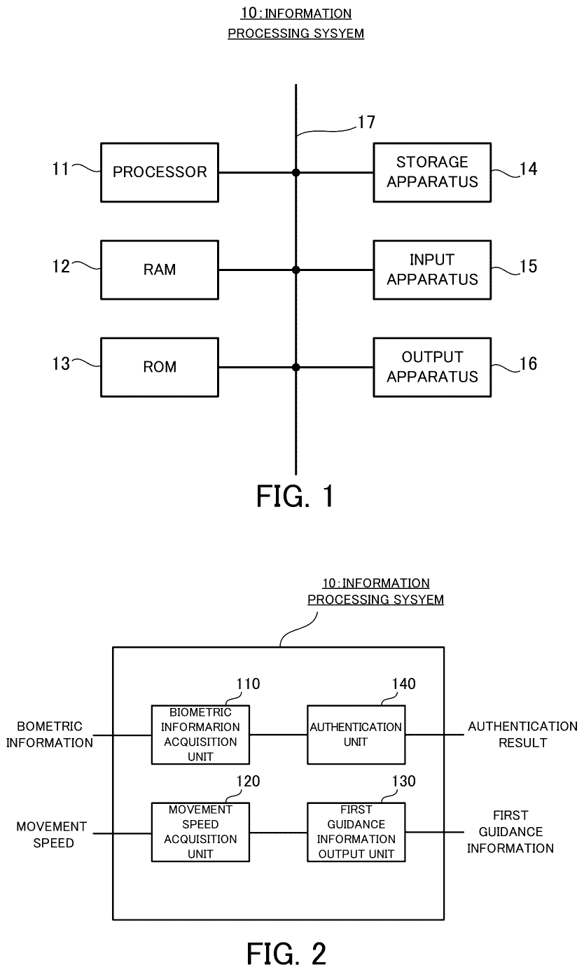

An information processing system according to a first example embodiment will be described with reference to FIG. 1 to FIG. 3.

### Hardware Configuration

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may also include an input apparatus 15 and an output apparatus 16. The processor 11, the RAM 12, the ROM 13, the storage apparatus 14, the input apparatus 15, and the output apparatus 16 are connected via a data bus 17.

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., may read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for performing class classification based on a likelihood ratio is realized in the processor 11. That is, the processor 11 may function as a controller for executing each control in the information processing system 10.

The processor 11 may be configured as, for example, a CPU (central processing unit), a GPU (graphics processing unit), a FPGA (field-programmable gate array), a DSP (Digital Signal Processor), an ASIC (Application Specific Integrated Circuit), and a quantum processor. The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may be used in place of the RAM 12.

The ROM 13 stores the computer program to be executed by the processor 11. The ROM 13 may also store fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the information processing system 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display device (e.g., a display) that is configured to display the information about the information processing system 10. The output apparatus 16 may be configured as a portable terminal such as a smartphone and a tablet. The output apparatus 16 may also be an apparatus that outputs the information in a format other than images. For example, the output apparatus 16 may be a speaker that outputs the information about the information processing system 10 in voice form.

Incidentally, some of the hardware described in FIG. 1 may be provided as external apparatus of the information processing system 10. For example, the information processing system 10 may be configured to include only the processor 11, the RAM 12, and the ROM 13 described above, and other components (i.e., the storage apparatus 14, the input apparatus 15, the output apparatus 16) may be provided by an external apparatus connected to the information processing system 10. In addition, the information processing system 10 may realize some arithmetic functions by an external apparatus (e.g., an external server or cloud, etc.).

### Functional Configuration

Next, a functional configuration of the information processing system 10 according to the first example embodiment will be described with reference to FIG. 2. FIG. 2 is a block diagram illustrating the functional configuration of the information processing system according to the first example embodiment.

The information processing system 10 according to the first example embodiment is configured to perform authentication using biometric information of a target moving in a predetermined area (hereinafter referred to as “biometric authentication”). The target here is not limited to humans, but may include animals such as dogs and cats, or robots. In a case where the target is a robot, authentication may be performed using an information about the robot's appearance as the biometric information. In addition, the “predetermined area” is an area that is set in advance as the area where biometric authentication is performed. For example, an area where a gate that determines whether or not passage is permitted based on the biometric authentication is installed may be set as the predetermined area.

As illustrated in FIG. 2, the information processing system 10 according to the first example embodiment is configured to include, as components for realizing its functions, a biometric information acquisition unit 110, a movement speed acquisition unit 120, a first guidance information output unit 130, and an authentication unit 140. Each of the biometric information acquisition unit 110, the movement speed acquisition unit 120, the first guidance information output unit 130, and the authentication unit 140 may be a processing block realized by the processor 11 described above (see FIG. 1), for example.

The biometric information acquisition unit 110 is configured to acquire biometric information from a target moving in a predetermined area. Examples of biometric information include faces, irises, fingerprints, palm prints, and the like. The biometric information acquisition unit 110 may acquire the biometric information from an image of the target, for example. In this case, the biometric information may be the image itself or feature quantities extracted from the image. The biometric information acquired by the biometric information acquisition unit 110 is output to the authentication unit 140.

The movement speed acquisition unit 120 is configured to acquire the movement speed of the target for acquiring biometric information. For example, in a case where the target is walking in a predetermined area, the movement speed acquisition unit 120 may acquire the walking speed of the target. The movement speed acquisition unit 120 may acquire the movement speed of the target using various sensors, for example. Alternatively, the movement speed acquisition unit 120 may acquire the movement speed of the target from images of the target. For example, the movement speed acquisition unit 120 may acquire the movement speed of the target from the degree of change in a position of the target in the image and the degree of change in a size of a face of the target by comparing a plurality of images. The information on the movement speed of the target acquired by the movement speed acquisition unit 120 is output to the first guidance output unit 130.

The first guidance information output unit 130 is configured to output first guidance information for changing the movement speed of the target based on the movement speed of the target acquired by the movement speed acquisition unit 120. The first guidance information output unit 130 may be configured to output the first guidance information in a case where the movement speed of the target exceeds or falls below a predetermined threshold value. Alternatively, the first guidance information output unit 130 may output first guidance information corresponding to the movement speed of the target. For example, the first guidance information may be information including a message prompting a change in the movement speed. More specifically, the first guidance information may include messages such as “Please walk a little slower” or “Please walk faster.” This message may be displayed as an image or output as a sound/voice. Alternatively, the first guidance information may be information indicating an appropriate movement speed (e.g., a speed suitable for acquiring biometric information). For example, the first guidance information may indicate a target movement speed by means of a speed at which lights blink or a period/pitch of a sound, etc. More specific examples of the first guidance information will be described in detail in other example embodiments described later.

The authentication unit 140 is configured to authenticate the target using the target biometric information acquired by the biometric information acquisition unit 110. In other words, the authentication unit 140 is configured to perform biometric authentication using the target biometric information. The authentication unit 140 may perform biometric authentication by comparing the biometric information acquired from the target with the biometric information registered in advance. A type of biometric authentication performed by the authentication unit 140 is not particularly limited, and maybe, for example, face authentication using a face image of the target, iris authentication using an iris image of the target, or multi-modal authentication combining multiple modalities. The authentication unit 140 may have a function for outputting the result of biometric authentication.

### Flow of Operation

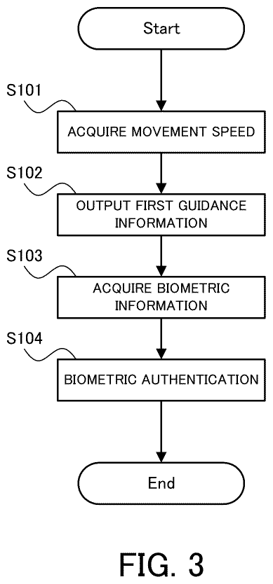

Next, with reference to FIG. 3, a flow of operation of the information processing system 10 according to the first example embodiment will be described. FIG. 3 is a flowchart illustrating the flow of the operation of the information processing system according to the first example embodiment.

As illustrated in FIG. 3, when an operation of the information processing system 10 according to the first example embodiment is started, first, the movement speed acquisition unit 120 acquires the movement speed of the target moving in the predetermined area (step S101). Then, the first guidance information output unit 130 outputs the first guidance information for changing the movement speed of the target, based on the movement speed of the target acquired by the movement speed acquisition unit 120 (step S102). As a result, the movement speed of the target moving in the predetermined area is changed to a more appropriate movement speed when performing authentication.

Incidentally, when the movement speed is acquired for the first time, if the movement speed of the target is already at an appropriate speed, the first guidance information output unit 130 may omit outputting the first guidance information as appropriate. That is, depending on the movement speed of the target, the first guidance information may not be output. Alternatively, the first guidance information output unit 130 may output guidance information that maintains the movement speed as is for the target with an appropriate movement speed. For example, the first guidance information output unit 130 may output a message such as “Please maintain your current speed.”

Next, the biometric information acquisition unit 110 acquires the biometric information of the target (step S103). That is, the biometric information acquisition unit 110 acquires biometric information from the target whose movement speed has changed due to the first guidance information. Then, the authentication unit 140 performs the biometric authentication of the target using the biometric information acquired by the biometric information acquisition unit 110 (step S104). A result of the biometric authentication may be used for various processes. For example, in a case where the biometric authentication is successful, a process for opening a gate that the target is about to pass through, a process for opening a door, a process for unlocking a lock, etc. may be executed. Conversely, in a case where the biometric authentication fails, a process for closing a gate that the target is about to pass through, a process for closing a door, a process for locking a lock, etc. may be executed.

### Technical Effect

Next, the technical effect obtained by the information processing system 10 according to the first example embodiment will be described.

As illustrated in FIG. 1 to FIG. 3, in the information processing system 10 according to the first example embodiment, the first guidance information is output based on the movement speed of the target. In this way, it is possible to guide the movement speed of the target moving in the predetermined area to a speed suitable for biometric authentication. In addition, by acquiring biometric information from a target whose movement speed has changed due to the first guidance information, it is possible to acquire biometric information suitable for the biometric authentication even in a case where the target is moving. As a result, it is possible to perform biometric authentication more appropriately.

### Second Example Embodiment

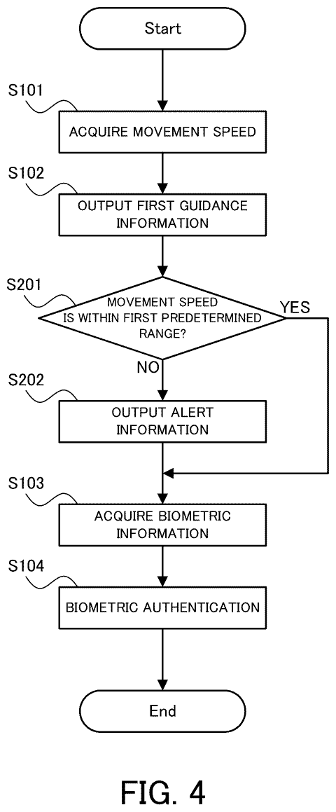

The information processing system 10 according to a second example embodiment will be described with reference to FIG. 4. The second example embodiment partially differs from the first example embodiment described above only in its operation, and may be the same as the first example embodiment in the other parts. For this reason, a part differing from the first example embodiment will be described in detail below, and a description of the other overlapping parts will be omitted as appropriate.

### Flow of Operation

First, with reference to FIG. 4, a flow of operation of the information processing system 10 according to the second example embodiment will be described. FIG. 4 is a flowchart illustrating the flow of operation of the information processing system according to the second example embodiment. In FIG. 4, the same reference numerals indicate the same processes as those described in FIG. 3.

As illustrated in FIG. 4, when an operation by the information processing system 10 according to the second example embodiment is started, first, the movement speed acquisition unit 120 acquires the movement speed of the target moving in the predetermined area (step S101). Then, the first guidance information output unit 130 outputs first guidance information for changing the movement speed of the target, based on the movement speed of the target acquired by the movement speed acquisition unit 120 (step S102).

Next, the first guidance information output unit 130 determines whether the movement speed of the target is within the first predetermined range (step S201). The “first predetermined range” here is a range set to determine whether the movement speed of the target is suitable for the biometric authentication (e.g., whether the speed is suitable for acquiring biometric information). The first predetermined range may be set, for example, as a range indicating a speed at which the face or iris of the target can be captured without motion blur.

If the movement speed of the target is not within the first predetermined range (step S201: NO), the first guidance information output unit 130 outputs an alert information (step S202). This alert information may be information notifying that the movement speed of the target is not suitable for the biometric authentication (e.g., extremely fast or slow). The alert information may be information output to the target or information output to users other than the target (e.g., a system administrator). In a case where the movement speed of the target is within the first predetermined range (step S201: YES), the processing of step S202 described above is omitted. That is, in a case where the movement speed of the target is within the first predetermined range, the alert information is not output.

Here, an example is given in which the first guidance information output unit 130 outputs the alert information after outputting the first guidance information, but the first guidance information output unit 130 may output the alert information before outputting the first guidance information. Alternatively, the first guidance information output unit 130 may output the first guidance information and the alert information simultaneously.

Then, the biometric information acquisition unit 110 acquires the target biometric information (step S103). Next, the authentication unit 140 performs the biometric authentication of the target using the biometric information acquired by the biometric information acquisition unit 110 (step S104). In a case where the alert information is output, it may not be possible to acquire the biometric information of the target normally. In such a case, the processing of the series of operations may be temporarily stopped without executing the processing of steps S103 and S104. Then, the processing of steps S103 and S104 may be resumed after the movement speed of the target has changed to an appropriate movement speed.

### Technical Effect

Next, the technical effect obtained by the information processing system 10 according to the second example embodiment will be described.

As illustrated in FIG. 4, in the information processing system 10 according to the second example embodiment, the alert information is output in addition to the first guidance information. In this way, it is possible not only to change the movement speed of the target but also to notify the target, etc. that the movement speed of the target is not suitable for the biometric authentication (e.g., the biometric authentication cannot be performed normally at the current movement speed).

### Third Example Embodiment

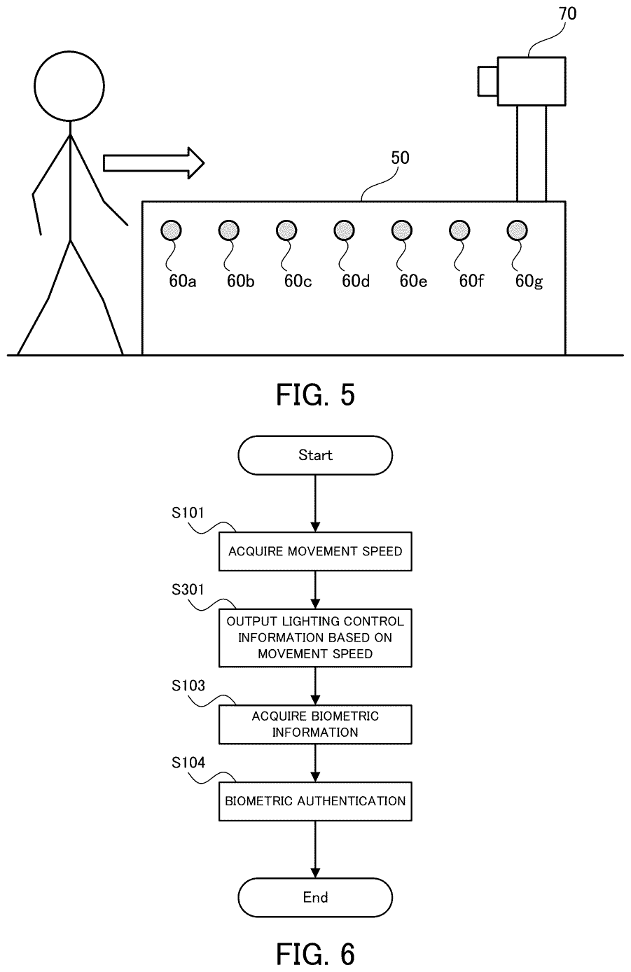

The information processing system 10 according to a third example embodiment will be described with reference to FIG. 5 and FIG. 6. The third example embodiment partially differs from the first and second example embodiments only in its configuration and operation, and may be the same as the first and second example embodiments in the other parts. For this reason, a part differing from each of the example embodiments described above will be described in detail below, and a description of the other overlapping parts will be omitted as appropriate.

### Gate Configuration

First, with reference to FIG. 5, a gate configuration to which the information processing system 10 according to the third example embodiment is applied will be described. FIG. 5 is a side view illustrating the gate configuration to which the information processing system according to the third example embodiment is applied.

As illustrated in FIG. 5, the information processing system 10 according to the third example embodiment is configured as a system including a gate 50 through which a target passes. This gate 50 may, for example, control the entry and exit of the target. For example, the gate 50 may be installed at a building entrance or an airport boarding gate.

A camera 70 for capturing an image of the target is provided at gate 50. The biometric information acquisition unit 110 may be configured to acquire the biometric information of the target from the image captured by the camera 70. In addition, a plurality of lighting 60a to g (hereinafter collectively referred to as “lighting 60”) are provided at gate 50. The lighting 60 may be, for example, an LED (Light Emitting Diode). The lighting 60 is controllable by the first guidance information output by the first guidance information output unit 130. In this example embodiment, the first guidance information output to control the lighting 60 is referred to as “lighting control information” as appropriate.

### Flow of Operation

Next, with reference to FIG. 6, a flow of operation of the information processing system 10 according to the third example embodiment will be described. FIG. 6 is a flowchart illustrating the flow of operation of the information processing system according to the third example embodiment. In FIG. 6, the same reference numerals indicate the same processes as those described in FIG. 3.

As illustrated in FIG. 6, when an operation of the information processing system 10 according to the third embodiment is started, first, the movement speed acquisition unit 120 acquires the movement speed of the target moving in the predetermined area (step S101). The movement speed acquisition unit 120 may acquire the movement speed of a target approaching the gate 50, for example. Alternatively, the movement speed acquisition unit 120 may acquire the movement speed of a target passing through the gate.

Particularly in this example embodiment, the first guidance information output unit 130 outputs the lighting control information based on the movement speed of the target acquired by the movement speed acquisition unit 120 (step S301). The lighting control information may be such as to change the blinking speed of the lighting 60 depending on the movement speed of the target. For example, the first guidance information output unit 130 may output the lighting control information so that the lighting 60 blinks at the target speed in a case where the movement speed of the target is too fast or too slow. Specifically, the moving speed of the target may be indicated by controlling a plurality of lights 60a to g to light up sequentially at an appropriate speed (for example, to light up from left to right in FIG. 5). Alternatively, the first guidance information output unit 130 may output the lighting control information to notify the target whether to speed up or slow down. For example, in a case where the movement speed of the target is too fast, the blinking speed of the lighting 60 may be slowed down to a speed slower than normal to guide the target to walk slowly. In addition, in a case where the movement speed of the target is too slow, the blinking speed of the lighting 60 may be accelerated to a speed faster than normal to guide the target to walk faster.

By controlling the lighting 60 as described above, the movement speed of the target is guided to an appropriate value. Thereafter, the biometric information acquisition unit 110 acquires the biometric information of the target (step S103). Then, the authentication unit 140 performs the biometric authentication of the target using the biometric information acquired by the biometric information acquisition unit 110 (step S104).

### Technical Effect

Next, the technical effect obtained by the information processing system 10 according to the third example embodiment will be described.

As illustrated in FIG. 5 and FIG. 6, in the information processing system 10 according to the third example embodiment, the blinking speed of the lighting 60 installed at the gate is changed in depending on the movement speed of the target. In this way, it is possible to guide the movement speed of the target to the appropriate value using the lighting 60. In this example embodiment, an example of guidance using a plurality of lighting 60a to g is described, but it is also possible to guide the target using only one lighting 60. For example, the target may be guided by changing the blinking speed of a single light 60 depending on the movement speed of the target. The lighting control information may also include information for changing the color of the lighting 60 in addition to the blinking speed of the lighting 60. For example, in a case where the target is to be guided more strongly, the color of the lighting 60 may be changed to a conspicuous color (e.g., red).

### Fourth Example Embodiment

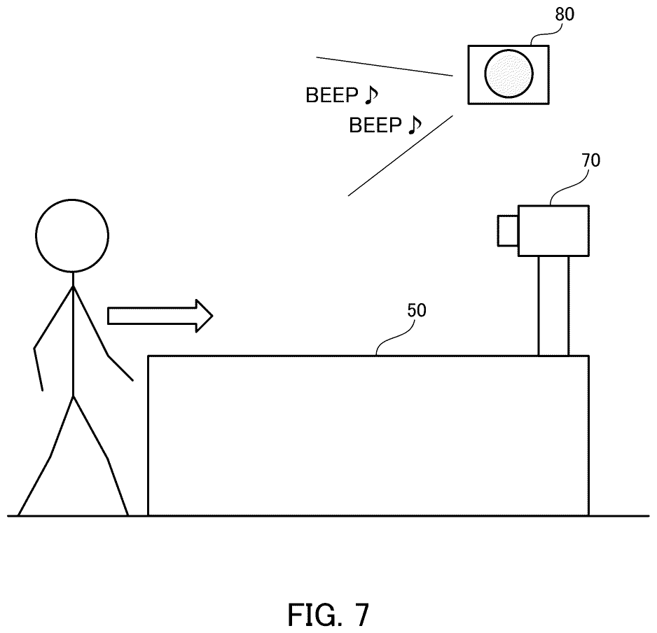

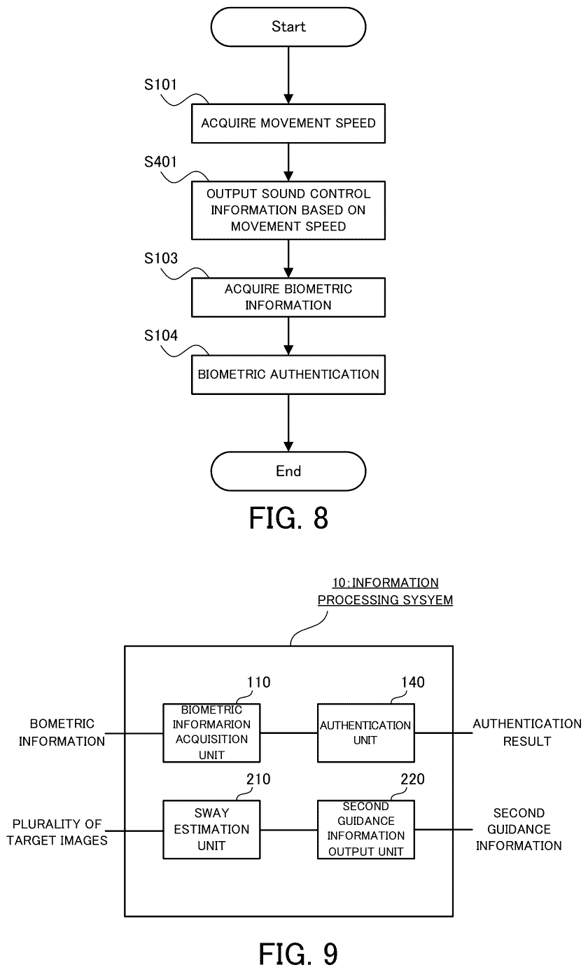

The information processing system 10 according to a fourth example embodiment will be described with reference to FIG. 7 and FIG. 8. The fourth example embodiment partially differs from the first to third example embodiments only in its configuration and operation, and may be the same as the first to third example embodiments in the other parts. For this reason, a part differing from each of the example embodiments described above will be described in detail below, and a description of the other overlapping parts will be omitted as appropriate.

### Gate Configuration

First, with reference to FIG. 7, a gate configuration to which the information processing system 10 according to the fourth example embodiment is applied will be described. FIG. 7 is a side view illustrating the gate configuration to which the information processing system according to the fourth example embodiment is applied. In FIG. 7, the same reference numerals indicate the same elements as those described in FIG. 5.

As illustrated in FIG. 7, in the information processing system 10 according to the fourth example embodiment, a speaker 80 is provided to output a sound toward the target existing in the vicinity of the gate 50. The speaker 80 is configured to output the sound corresponding to the first guidance information output by the first guidance information output unit 130. In this example embodiment, the first guidance information for outputting the sound from the speaker 80 is referred to as “sound control information” as appropriate. The sound output from the speaker 80 may be a mechanical sound such as “beep, beep” or an arbitrary musical piece.

### Flow of Operation

Next, with reference to FIG. 8, a flow of operation of the information processing system 10 according to the fourth example embodiment will be described. FIG. 8 is a flowchart illustrating the flow of operation of the information processing system according to the fourth example embodiment. In FIG. 8, the same reference numerals indicate the same processes as those described in FIG. 3.

As illustrated in FIG. 8, when an operation of the information processing system 10 according to the fourth example embodiment is started, first, the movement speed acquisition unit 120 acquires the movement speed of the target moving in the predetermined area (step S101). The movement speed acquisition unit 120 may acquire the movement speed of the target approaching the gate 50, for example. Alternatively, the movement speed acquisition unit 120 may acquire the movement speed of the target passing through the gate.

Particularly in this example embodiment, the first guidance information output unit 130 outputs the sound control information based on the movement speed of the target acquired by the movement speed acquisition unit 120 (step S401). The sound control information may be such as to change the period/pitch of the sound output from the speaker 80 corresponding to the movement speed of the target. For example, the first guidance information output unit 130 may output the sound control information so that the pitch of the sound output from the speaker 80 becomes the pitch corresponding to the movement speed of the target in a case where the movement speed of the target is too fast or too slow. In this case, the pitch may be a value calculated from the stride length of the target, for example. Alternatively, the first guidance information output unit 130 may output the sound control information to notify the target whether it should move faster or slower. For example, in a case where the movement speed of the target is too fast, the pitch of the sound may be slowed down more than normal to guide the target to walk more slowly. Also, in a case where the movement speed of the target is too slow, the pitch of the sound may be made faster than normal to guide the target to walk faster.

By controlling the speaker 80 as described above, the movement speed of the target is guided to an appropriate value. Thereafter, the biometric information acquisition unit 110 acquires the biometric information of the target (step S103). Then, the authentication unit 140 performs the biometric authentication of the target using the biometric information acquired by the biometric information acquisition unit 110 (step S104).

### Technical Effect

Next, the technical effect obtained by the information processing system 10 according to the fourth example embodiment will be described.

As illustrated in FIG. 7 and FIG. 8, in the information processing system 10 according to the fourth example embodiment, the pitch of the sound output from the speaker 80 is changed corresponding to the movement speed of the target. In this way, it is possible to guide the movement speed of the target to the appropriate value using the sound output from the speaker 80. The sound for guiding the target may be output from a source other than the speaker 80. For example, the sound for guiding the target may be a sound output from a terminal (e.g., a smartphone) held by the target.

### Fifth Example Embodiment

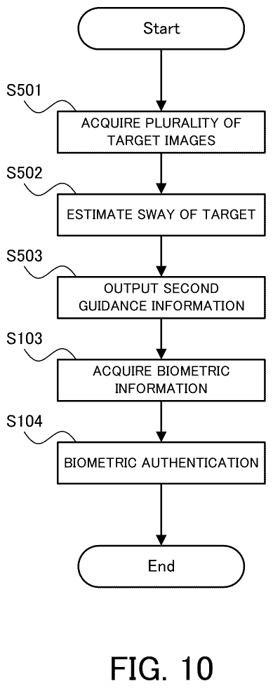

The information processing system 10 according to a fifth example embodiment will be described with reference to FIG. 9 and FIG. 10. The fifth example embodiment partially differs from the first to fourth example embodiments only in its configuration and operation, and may be the same as the first to fourth example embodiments in the other parts. For this reason, a part differing from each of the example embodiments described above will be described in detail below, and a description of the other overlapping parts will be omitted as appropriate.

### Functional Configuration

First, a functional configuration of the information processing system 10 according to the fifth example embodiment will be described with reference to FIG. 9. FIG. p is a block diagram illustrating the functional configuration of the information processing system according to the fifth example embodiment. In FIG. 9, the same reference numerals indicate the same elements as those described in FIG. 2.

As illustrated in FIG. 9, the information processing system 10 according to the fifth example embodiment is configured to include, as components for realizing its functions, the biometric information acquisition unit 110, the authentication unit 140, a sway estimation unit 210, and a second guidance information output unit 220. That is, the information processing system 10 according to the fifth example embodiment is provided with the sway estimation unit 210 and the second guidance information output unit 220 instead of the movement speed acquisition unit 120 and the first guidance information output unit 130 in the first example embodiment (see FIG. 2). The sway estimation unit 210 and the second guidance information output unit 220 may each be a processing block realized by the processor 11 described above (see FIG. 1), for example.

The sway estimation unit 210 is configured to estimate a movement sway (e.g., a vertical sway or a horizontal sway when walking) caused by the movement of the target moving in the predetermined area. More specifically, the sway estimation unit 210 estimates the movement sway of the target from a plurality of target images captured of the target moving in the predetermined area. For example, the sway estimation unit 210 may estimate the movement sway of the target by calculating how the position of the target changes by comparing the plurality of target images that are continuous in time. More specifically, the sway estimation unit 210 may estimate the movement sway of the target from changes in the position of a predetermined part (e.g., an eye, etc.) of the target in the plurality of target images. Alternatively, the sway estimation unit 210 may detect periodic changes in a predetermined part of the target in the plurality of target images and estimate the amount of change in the detected periodic changes as the movement sway of the target. In this case, the sway estimation unit 210 may not estimate non-periodic changes in the predetermined part of the target (e.g., sudden changes such as tripping over something or bending down to pick up something) as movement sway. In this way, it is possible to prevent sudden sway that should not be targeted for guidance, as described later, from being unintentionally estimated as movement sway. The information regarding the movement sway of the target estimated by the sway estimation unit 210 is output to the second guidance information output unit 220.

The second guidance information output unit 220 is configured to output a second guidance information for changing the movement sway of the target, based on the movement sway of the target estimated by the sway estimation unit 210. The second guidance information output unit 220 may output the second guidance information in a case where the movement sway of the target exceeds a predetermined threshold value. Alternatively, the second guidance information output unit 220 may output the second guidance information corresponding to the movement sway of the target. For example, the second guidance information may be information including a message prompting the target to change its movement sway. More specifically, the second guidance information may include messages such as “Please walk without swaying vertically” or “Please walk without swaying horizontally”. This message may be displayed as an image or output as an audio. Alternatively, the message may be output as both the image and the audio. The second guidance information may also be information that is expected to be effective in suppressing the movement sway of the target. For example, the second guidance information may be information for notifying the target that its movement sway is large. Alternatively, the second guidance information may be information for displaying a video that the target will focus on. More specific examples of the second guidance information will be explained in detail in other example embodiments described later.

### Flow of Operation

Next, with reference to FIG. 10, a flow of operation of the information processing system 10 according to the fifth example embodiment will be described. FIG. 10 is a flowchart illustrating the flow of operation of the information processing system according to the fifth example embodiment. In FIG. 10, the same reference numerals indicate the same processes as those described in FIG. 3.

As illustrated in FIG. 10, when an operation of the information processing system 10 according to the fifth embodiment is started, first, the sway estimation unit 210 acquires the plurality of images of the target moving in a predetermined area (step S501). Next, the sway estimation unit 210 estimates the movement sway of the target from the acquired plurality of images of the target (step S502). Then, the second guidance information output unit 220 outputs the second guidance information for changing the movement sway of the target, based on the movement sway of the target acquired by the sway estimation unit 210 (step S503). As a result, the movement sway of the target moving in the predetermined area becomes smaller.

When the movement sway of the target is acquired for the first time, if the movement sway of the target is already small (i.e., there is no adverse effect on the biometric authentication due to the sway), the second guidance information output unit 220 may omit the output of the second guidance information as appropriate. In other words, depending on the movement sway of the target, the second guidance information may not be output. Alternatively, the second guidance information output unit 130 may output guidance information that maintains the walking style for targets with little movement sway. For example, the second guidance information output unit 220 may output a message such as “Please maintain your current walking style”.

Next, the biometric information acquisition unit 110 acquires the biometric information of the target (step S103). That is, the biometric information acquisition unit 110 acquires the biometric information from the target whose movement sway has been reduced by the first guidance information. Then, the authentication unit 140 performs the biometric authentication of the target using the biometric information acquired by the biometric information acquisition unit 110 (step S104).

### Technical Effect

Next, the technical effect obtained by the information processing system 10 according to the fifth example embodiment will be described.

As illustrated in FIG. 9 and FIG. 10, in the information processing system 10 according to the fifth example embodiment, the second guidance information is output based on the movement sway of the target. In this way, it is possible to guide the target moving in the predetermined area so as to reduce the movement sway of the target. In addition, by estimating the periodic change of the predetermined part of the target as the movement sway, it is possible to detect the movement sway of the target appropriately. Then, by acquiring the biometric information from the target whose movement sway has been reduced by the second guidance information, it is possible to acquire the biometric information suitable for the biometric authentication even in a case where the target is moving. As a result, it is possible to perform the biometric authentication more appropriately.

In the fifth example embodiment, only the second guidance information is output, and the first guidance information described in the first to fourth example embodiments is not output, but the information processing system 10 may be configured to output both the first guidance information and the second guidance information. That is, the information processing system 10 may be configured to output the first guidance information depending on the movement speed of the target and to output the second guidance information depending on the movement sway of the target.

### Sixth Example Embodiment

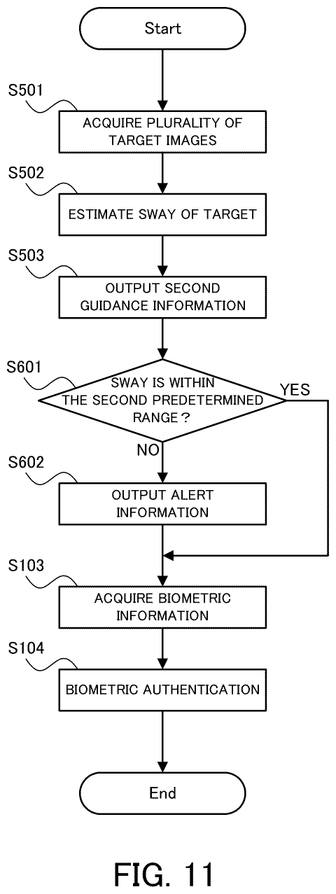

The information processing system 10 according to a sixth example embodiment will be described with reference to FIG. 11. The sixth example embodiment partially differs from the fifth example embodiments only in its operation, and may be the same as the first to fifth example embodiments in the other parts. For this reason, a part differing from each of the example embodiments described above will be described in detail below, and a description of the other overlapping parts will be omitted as appropriate.

### Flow of Operation

First, with reference to FIG. 11, a flow of operation of the information processing system 10 according to the sixth example embodiment will be described. FIG. 11 is a flowchart illustrating the flow of operation of the information processing system according to the sixth example embodiment. In FIG. 11, the same reference numerals indicate the same processes as those described in FIG. 10.

As illustrated in FIG. 11, when an operation of the information processing system 10 according to the sixth example embodiment is started, first, the sway estimation unit 210 acquires the plurality of images of the target moving in the predetermined area (step S501). Next, the sway estimation unit 210 estimates the movement sway of the target from the acquired plural images of the target (step S502). Then, the second guidance information output unit 220 outputs the second guidance information for changing the movement sway of the target, based on the movement sway of the target acquired by the sway estimation unit 210 (step S503).

Next, the second guidance information output unit 220 determines whether the movement sway of the target is within the second predetermined range (step S601). The “second predetermined range” here is a range set to determine whether the movement sway of the target is large enough to affect the biometric authentication (e.g., whether the sway is so large that it is difficult to acquire the biometric information). The second predetermined range may be set, for example, as a range of sway that allows the face or iris of the target to be captured without motion blur, or as a range in which the face or iris of the target fits within the angle of view of the camera.

In a case where the movement sway of the target is not within the second predetermined range (step S601: NO), the second guidance information output unit 220 outputs an alert information (step S602). This alert information may be information notifying that the movement sway of the target is not suitable for the biometric authentication (e.g., the target is swaying greatly). The alert information may be information output to the target or information output to a user other than the target (e.g., a system administrator). In a case where the movement sway of the target is within the second predetermined range (step S601: YES), the process of step S602 described above is omitted. That is, in a case where the movement sway of the target is within the second predetermined range, the alert information is not output.

Here, an example is given in which the second guidance information output unit 220 outputs the alert information after outputting the second guidance information, but the second guidance information output unit 220 may output the alert information before outputting the second guidance information. Alternatively, the second guidance information output unit 220 may output the second guidance information and the alert information simultaneously.

After that, the biometric information acquisition unit 110 acquires the biometric information of the target (step S103). Then, the authentication unit 140 performs biometric authentication of the target using the biometric information acquired by the biometric information acquisition unit 110 (step S104). In a situation where the alert information is output, it may not be possible to acquire the biometric information of the target normally. In such a case, the process of steps S103 and S104 is not executed, and the series of operations may be temporarily stopped. Then, after the movement sway of the target becomes of an appropriate amount, the process of steps S103 and S104 may be resumed.

### Technical Effect

Next, the technical effect obtained by the information processing system 10 according to the sixth example embodiment will be described.

As illustrated in FIG. 11, in the information processing system 10 according to the sixth example embodiment, the alert information is output in addition to the second guidance information. In this way, not only is the movement sway of the target reduced, but it is also possible to notify the target, etc. that the movement sway of the target is not suitable for the biometric authentication (e.g., the biometric authentication cannot be performed normally with the sway as it is).

### Seventh Example Embodiment

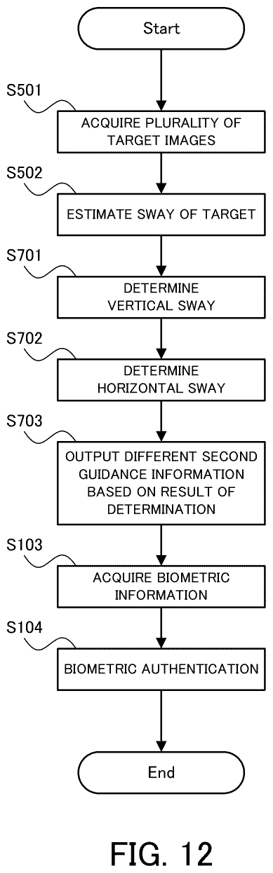

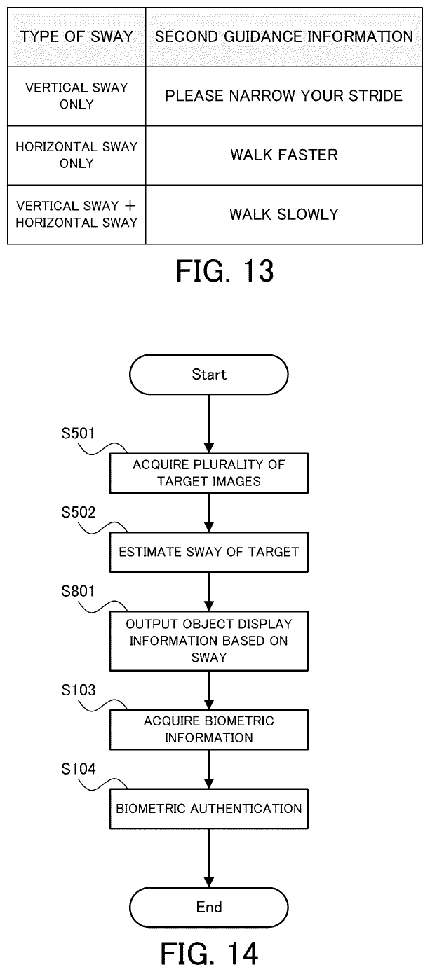

The information processing system 10 according to a seventh example embodiment will be described with reference to FIG. 12 and FIG. 13. The seventh example embodiment partially differs from the fifth and sixth example embodiments only in its configuration and operation, and may be the same as the first to sixth example embodiments in the other parts. For this reason, a part differing from each of the example embodiments described above will be described in detail below, and a description of the other overlapping parts will be omitted as appropriate.

### Flow of Operation

First, with reference to FIG. 12, a flow of operation of the information processing system 10 according to the seventh example embodiment will be described. FIG. 12 is a flowchart illustrating the flow of operation of the information processing system according to the seventh example embodiment. In FIG. 12, the same reference numerals indicate the same processes as those described in FIG. 10.

As illustrated in FIG. 12, when an operation by the information processing system 10 according to the seventh example embodiment is started, first, the sway estimation unit 210 acquires the plurality of images of the target moving in the predetermined area (step S501). Then, the sway estimation unit 210 estimates the movement sway of the target from the acquired plurality of target images (step S502).

Next, the second guidance information output unit 220 determines whether the vertical sway (i.e., sway in the vertical direction) included in the movement sway of the target exceeds a predetermined vertical threshold (step S701). Here, the “vertical sway” indicates the degree of change in the vertical direction of the eye position of the target. The “vertical threshold” is a range set to determine whether the vertical sway of the target is large enough to affect the biometric authentication. The second guidance information output unit 220 also determines whether the horizontal sway (i.e., sway in the horizontal direction) included in the movement sway of the target exceeds a predetermined horizontal threshold (step S702). Here, the “horizontal sway” indicates the degree of change in the horizontal direction of the eye position of the target. The “horizontal threshold” is a range set to determine whether the horizontal sway of the target is large enough to affect the biometric authentication.

Next, the second guidance information output unit 220 outputs the second guidance information based on the results of the determination in steps S701 and S702 (step S703). Specifically, the second guidance information output unit 220 outputs different second guidance information depending on whether the vertical sway exceeds the vertical threshold, the horizontal sway exceeds the horizontal threshold, or both the vertical sway exceeds the vertical threshold and the horizontal sway exceeds the horizontal threshold.

Thereafter, the biometric information acquisition unit 110 acquires the biometric information of the target (step S103). Then, the authentication unit 140 performs the biometric authentication of the target using the biometric information acquired by the biometric information acquisition unit 110 (step S104).

### Specific Example of Guidance Information

Next, with reference to FIG. 13, a specific example of the second guidance information output by the information processing system 10 according to the seventh example embodiment will be described. FIG. 13 is a table illustrating an example of output of the second guidance information in the information processing system according to the seventh example embodiment.

As illustrated in FIG. 13, in the information processing system 10 according to the seventh example embodiment, in a case where the vertical sway of the target exceeds the vertical threshold, a message “Please narrow your stride” is output as the second guidance information. Since the vertical sway is likely to occur when walking with large strides, guiding the target to take smaller steps can be expected to reduce the vertical sway. In addition, in a case where the horizontal sway of the target exceeds the horizontal threshold, a message “Walk faster” is output as the second guidance information. Since the horizontal sway is likely to occur when walking like a model, guiding the target to walk faster can be expected to reduce the horizontal sway. In addition, in a case where the vertical sway of the target exceeds the vertical threshold and the horizontal sway exceeds the horizontal threshold, a message “Walk slowly” is output as the second guidance information. In a case where both the vertical sway and the horizontal sway are large, it is thought that the cause may be that the target is walking too fast, so it can be expected that guiding the target to walk slowly will reduce the vertical sway and the horizontal sway.

### Technical Effect

Next, the technical effect obtained by the information processing system 10 according to the seventh example embodiment will be described.

As illustrated in FIG. 12 and FIG. 13, in the information processing system 10 according to the seventh example embodiment, the second guidance information is output differently according to the direction of a sway included in the movement sway of the target. Since the causes of the vertical sway and the horizontal sway may be different, it is possible to perform guidance to effectively reduce the vertical sway and the horizontal sway by outputting the second guidance information according to the movement sway.

### Eighth Example Embodiment

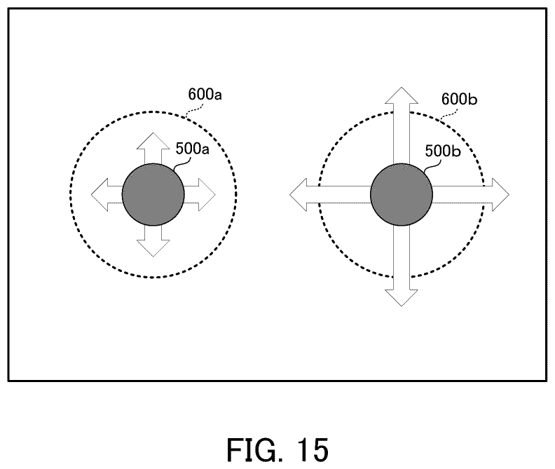

The information processing system 10 according to an eighth example embodiment will be described with reference to FIG. 14 and FIG. 15. The eighth example embodiment partially differs from the fifth to seventh example embodiments only in its configuration and operation, and may be the same as the first to seventh example embodiments in the other parts. For this reason, a part differing from each of the example embodiments described above will be described in detail below, and a description of the other overlapping parts will be omitted as appropriate.

### Flow of Operation

First, with reference to FIG. 14, a flow of operation of the information processing system 10 according to the eighth example embodiment will be described. FIG. 14 is a flowchart illustrating the flow of operation of the information processing system according to the eighth example embodiment. In FIG. 14, the same reference numerals indicate the same processes as those described in FIG. 10.

As illustrated in FIG. 14, when an operation by the information processing system 10 according to the eighth example embodiment is started, first, the sway estimation unit 210 acquires the plurality of images of the target moving in the predetermined area (step S501). Then, the sway estimation unit 210 estimates the movement sway of the target from the acquired plurality of target images (step S502).

Next, the second guidance information output unit 220 outputs an object display information based on the movement sway of the target estimated by the sway estimation unit 210 (step S801). The object display information here is information output as the second guidance information, and is information for displaying an object that moves corresponding to the movement sway of the target. The object may be displayed on a display installed in a predetermined area, for example. Alternatively, the object may be displayed on a display of a terminal (e.g., a smartphone etc.) held by the user.

The object is displayed so that it moves corresponding to the direction and amount of the movement sway of the target. Therefore, if the object is displayed toward the target, the target can appropriately grasp its own movement sway. As a result, the target attempts to walk so that its movement sway becomes smaller. After the movement sway of the target is reduced by displaying the object, the biometric information acquisition unit 110 acquires the biometric information of the target (step S103). Then, the authentication unit 140 performs biometric authentication of the target using the biometric information acquired by the biometric information acquisition unit 110 (step S104).

### Example of Object Display

Next, with reference to FIG. 15, a specific example of an object displayed by the information processing system 10 according to the eighth example embodiment will be described. FIG. 15 is a plan view illustrating an example of an object displayed by the information processing system according to the eighth example embodiment.

As illustrated in FIG. 15, in the information processing system 10 according to the eighth example embodiment, an object simulating a human eyeball may be displayed. Specifically, black eye objects 500a and 500b corresponding to the black part of the eye and threshold lines 600a and 600b corresponding to the white part of the eye may be displayed.

The black eye objects 500a and 500b move up, down, left, and right corresponding to the direction of the movement sway of the target. For example, in a case where the target is swaying vertically, the black eye objects 500a and 500b move in the up and down directions. In addition, in a case where the target is swaying horizontally, the black eye objects 500a and 500b move in the left and right directions. Furthermore, the black eye objects 500a and 500b move with an oscillation amplitude corresponding to the amplitude of the sway. For example, in a case where the target sways slightly, the black eye objects 500a and 500b also move with a small oscillation amplitude. In addition, in a case where the target sways greatly, the black eye objects 500a and 500b also move with a large oscillation amplitude.

The threshold lines 600a and 600b are displayed as thresholds for determining the magnitude of movement sway. The threshold lines 600a and 600b may be displayed as lines corresponding to the first predetermined range described in the second example embodiment or the second predetermined range described in the sixth example embodiment, for example. In this case, when the oscillation amplitude of black eye objects 500a and 500b becomes large and exceeds threshold lines 600a and 600b, the alert information is output.

### Technical Effect

Next, the technical effect obtained by the information processing system 10 according to the eighth example embodiment will be described.

As illustrated in FIG. 14 and FIG. 15, in the information processing system 10 according to the eighth example embodiment, the object moves corresponding to the direction and magnitude of the sway of the target. In this way, it is possible to enable the target to appropriately grasp its own sway and to provide more appropriate guidance.

### Ninth Example Embodiment

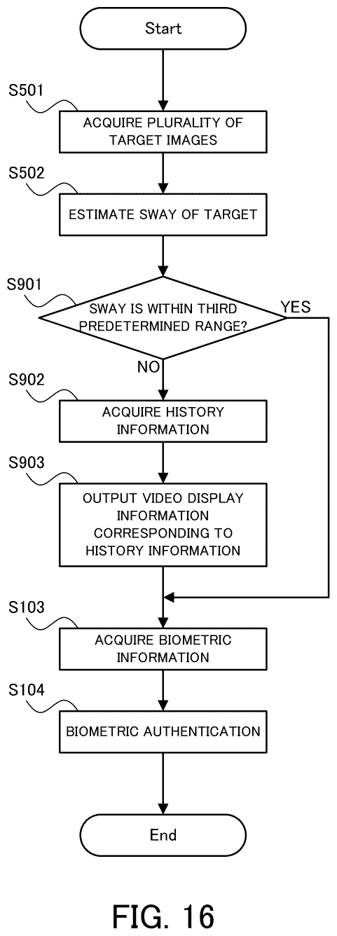

The information processing system 10 according to a ninth example embodiment will be described with reference to FIG. 16. The ninth example embodiment partially differs from the fifth to eighth example embodiments only in its configuration and operation, and may be the same as the first to eighth example embodiments in the other parts. For this reason, a part differing from each of the example embodiments described above will be described in detail below, and a description of the other overlapping parts will be omitted as appropriate.

### Flow of Operation

First, with reference to FIG. 16, a flow of operation of the information processing system 10 according to the ninth example embodiment will be described. FIG. 16 is a flowchart illustrating the flow of operation of the information processing system according to the ninth example embodiment. In FIG. 16, the same reference numerals indicate the same processes as those described in FIG. 10.

As illustrated in FIG. 16, when an operation by the information processing system 10 according to the ninth example embodiment is started, first, the sway estimation unit 210 acquires the plurality of images of the target moving in the predetermined area (step S501). Then, the sway estimation unit 210 estimates the movement sway of the target from the acquired plurality of target images (step S502).

Next, the second guidance information output section 220 determines whether the movement sway of the target estimated by the sway estimation section 210 is within a third predetermined range (step S901). The “third predetermined range” here is a range set to determine whether the movement sway of the target is large enough to affect the biometric authentication (e.g., whether the sway is large enough to make it difficult to acquire the biometric information). The third predetermined range may be set, for example, as a range of the movement sway that allows the face or iris of the target to be captured without motion blur.

In a case where the movement sway of the target is not within the third predetermined range (step S901: NO), the second guidance information output unit 220 acquires a history information from a terminal (e.g., a smartphone, etc.) held by the target (step S902). The history information may be, for example, information related to the search history or browsing history of the target. Then, the second guidance information output unit 220 outputs information for displaying a video corresponding to the acquired history information (hereinafter referred to as “video display information” as appropriate). The video display information is output as the second guidance information.

The video displayed by the video display information may be displayed on a display installed in the predetermined area. Alternatively, the video displayed by the video display information may be displayed on the display of the terminal owned by the user. The video display information is output based on the history information obtained from the terminal owned by the target as described above. For this reason, the video displayed by the video display information is a video that the target is interested in. Therefore, in a case where the video is displayed, the target is expected to pay close attention to the video.

According to the research of the inventor of the present invention, it has been found that when a target moves while staring at a single point, the movement sway of the target tends to become smaller. Therefore, by displaying images that interest the target, the movement sway of the target becomes smaller. After the movement sway of the target becomes smaller, the biometric information acquisition unit 110 acquires the biometric information of the target (step S103). Then, the authentication unit 140 performs the biometric authentication of the target using the biometric information acquired by the biometric information acquisition unit 110 (step S104).

### Technical Effect

Next, the technical effect obtained by the information processing system 10 according to the ninth example embodiment will be described.

As illustrated in FIG. 16, in the information processing system 10 according to the ninth example embodiment, the video is displayed based on the history information acquired from the terminal held by the target. In this way, it is possible to reduce the movement sway of the target by having the target focus on the video. As a result, it is possible to perform the biometric authentication more appropriately.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of SaaS (Software as a Service), for example.

### Supplementary Notes

The example embodiments described above may be further described as, but not limited to, the following Supplementary Notes below.

### Supplementary Note 1

An information processing system according to Supplementary Note 1 is an information processing system including: a biometric information acquisition unit that acquires biometric information from a target moving in a predetermined area; a movement speed acquisition unit that acquires a movement speed of the target; a first output unit that outputs a first guidance information for changing the movement speed of the target, based on the movement speed of the target; and an authentication unit that authenticates the target using the biometric information of the target.

### Supplementary Note 2

An information processing system according to Supplementary Note 2 is the information processing system according to Supplementary Note 1, wherein the biometric information acquisition unit is configured to acquire the biometric information of the target whose movement speed changed by an output of the first guidance information, and the authentication unit is configured to authenticate the target using the biometric information of the target whose movement speed changed.

### Supplementary Note 3

An information processing system according to Supplementary Note 3 is the information processing system according to Supplementary Note 1 or 2, wherein the first output unit is configured to output an alert information in addition to the first guidance information in a case where the movement speed of the target is not within a first predetermined range.

### Supplementary Note 4

An information processing system according to Supplementary Note 4 is the information processing system according to any one of Supplementary Notes 1 to 3, wherein the first guidance information is a lighting control information that blinks a lighting placed so as to be visible to the target., and the first output unit is configured to output the lighting control information so as to change the blinking speed of the lighting depending on the movement speed of the target.

### Supplementary Note 5

An information processing system according to Supplementary Note 5 is the information processing system according to any one of Supplementary Notes 1 to 4, wherein the first guidance information is a sound control information that outputs a sound toward the target, the first output unit is configured to output the sound control information so as to change a period of the sound depending on the movement speed of the target.

### Supplementary Note 6

An information processing system according to Supplementary Note 6 is an information processing system including: a target image acquisition unit that captures a target moving in a predetermined area and acquires a plurality of target images containing biometric information of the target; a sway estimation unit that estimates movement sway caused by a movement of the target in the target image, based on the target image; a second output unit that outputs a second guidance information for changing the movement sway of the target, based on the movement sway of the target; and an authentication unit that authenticates the target using the biometric information of the target.

### Supplementary Note 7

An information processing system according to Supplementary Note 7 is the information processing system according to Supplementary Note 6, wherein the sway estimation unit is configured to estimate an amount of periodic change in a predetermined part of the target as the movement sway of the target in a case where periodic change exists in the predetermined part of the target in the plurality of target images.

### Supplementary Note 8

An information processing system according to Supplementary Note 8 is the information processing system according to Supplementary Note 6 or 7, wherein the biometric information acquisition unit is configured to acquire the biometric information of the target whose movement sway changed by an output of the second guidance information, and the authentication unit is configured to authenticate the target using the biometric information of the target whose movement sway changed.

### Supplementary Note 9

An information processing system according to Supplementary Note 9 is the information processing system according to Supplementary Note 6 or 7, wherein the second output unit is configured to output an alert information in addition to the second guidance information in a case where the movement sway of the target is not within a second predetermined range.

### Supplementary Note 10

An information processing system according to Supplementary Note 10 is the information processing system according to any one of Supplementary Notes 6 to 9, wherein the movement sway of the target includes an information on a vertical direction change and a horizontal direction change of eyes position of the target, and the second output unit is configured to output different second guidance information, in a case where the vertical direction change exceeds a vertical direction threshold, in a case where the horizontal direction change exceeds a horizontal direction threshold, and in a case where the vertical direction change exceeds the vertical direction threshold and the horizontal direction change exceeds the horizontal direction threshold, respectively.

### Supplementary Note 11

An information processing system according to Supplementary Note 11 is the information processing system according to any one of Supplementary Notes 6 to 10, wherein the second guidance information is an object display information that displays an object so as to be visible to the target, and the second output unit is configured to output the object information so that the object moves depending on a direction and an amount of movement of the target.

### Supplementary Note 12

An information processing system according to Supplementary Note 12 is the information processing system according to any one of Supplementary Notes 6 to 11, wherein the second guidance information is a video display information that displays a video so as to be visible to the target, and the second output unit is configured to acquire a history information from a terminal held by the target, and output the video display information so as to display the video corresponding to the history information.

### Supplementary Note 13

An information processing method according to Supplementary Note 13 is an information processing method that is executed by at least one computer, the information processing method including: acquiring biometric information from a target moving in a predetermined area; acquiring a movement speed of the target; outputting a first guidance information for changing the movement speed of the target, based on the movement speed of the target; and authenticating the target using the biometric information of the target.

### Supplementary Note 14

An information processing method according to Supplementary Note 14 is an information processing method that is executed by at least one computer, the information processing method including: capturing a target moving in a predetermined area and acquiring a plurality of target images containing biometric information of the target; estimating movement sway caused by a movement of the target in the target image, based on the target image; outputting a second guidance information for changing the movement sway of the target, based on the movement sway of the target; and authenticating the target using the biometric information of the target.

### Supplementary Note 15

A recording medium according to Supplementary Note 15 is a recording medium on which a computer program that allows at least one computer to execute an information processing method is recorded, the information processing method including: acquiring biometric information from a target moving in a predetermined area; acquiring a movement speed of the target; outputting a first guidance information for changing the movement speed of the target, based on the movement speed of the target; and authenticating the target using the biometric information of the target.

### Supplementary Note 16

A recording medium according to Supplementary Note 16 is a recording medium on which a computer program that allows at least one computer to execute an information processing method is recorded, the information processing method including: capturing a target moving in a predetermined area and acquiring a plurality of target images containing biometric information of the target; estimating movement sway caused by a movement of the target in the target image, based on the target image; outputting a second guidance information for changing the movement sway of the target, based on the movement sway of the target; and authenticating the target using the biometric information of the target.

### Supplementary Note 17

A computer program according to Supplementary Note 17 is a computer program that allows at least one computer to execute an information processing method, the information processing method including: acquiring biometric information from a target moving in a predetermined area; acquiring a movement speed of the target; outputting a first guidance information for changing the movement speed of the target, based on the movement speed of the target; and authenticating the target using the biometric information of the target.

### Supplementary Note 18

A computer program according to Supplementary Note 18 is a computer program that allows at least one computer to execute an information processing method, the information processing method including: capturing a target moving in a predetermined area and acquiring a plurality of target images containing biometric information of the target; estimating movement sway caused by a movement of the target in the target image, based on the target image; outputting a second guidance information for changing the movement sway of the target, based on the movement sway of the target; and authenticating the target using the biometric information of the target.

The present disclosure is allowed to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
11 Processor
50 Gate
60 Lighting
70 Camera
80 Speaker
110 Biometric information acquisition unit
120 Movement speed acquisition unit
130 First guidance information output unit
140 Authentication unit
210 Sway estimation unit
220 Second guidance information output unit
500 Black eye object
600 Threshold line

What is claimed is:

1. An information processing system comprising:
at least one memory that is configured to store instructions; and
at least one processor that is configured to execute the instructions to:
acquire biometric information from a target moving in a predetermined area;
acquire a movement speed of the target;
output a first guidance information for changing the movement speed of the target, based on the movement speed of the target; and
authenticate the target using the biometric information of the target.

2. The information processing system according to claim 1, wherein the at least one processor is configured to execute the instructions to:
acquire the biometric information of the target whose movement speed changed by an output of the first guidance information, and
authenticate the target using the biometric information of the target whose movement speed changed.

3. The information processing system according to claim 1, wherein the at least one processor is configured to execute the instructions to:
output an alert information in addition to the first guidance information in a case where the movement speed of the target is not within a first predetermined range.

4. The information processing system according to claim 1, wherein
the first guidance information is a lighting control information that blinks a lighting placed so as to be visible to the target, and
the at least one processor is configured to execute the instructions to:
output the lighting control information so as to change the blinking speed of the lighting depending on the movement speed of the target.

5. The information processing system according to claim 1, wherein
the first guidance information is a sound control information that outputs a sound toward the target,
the at least one processor is configured to execute the instructions to:
output the sound control information so as to change a period of the sound depending on the movement speed of the target.

6. An information processing system comprising:
at least one memory that is configured to store instructions; and
at least one processor that is configured to execute the instructions to:
capture a target moving in a predetermined area and acquires a plurality of target images containing biometric information of the target;
estimate movement sway caused by a movement of the target in the target image, based on the target image;
output a second guidance information for changing the movement sway of the target, based on the movement sway of the target; and
authenticate the target using the biometric information of the target.

7. The information processing system according to claim 6, wherein the at least one processor is configured to execute the instructions to:
estimate an amount of periodic change in a predetermined part of the target as the movement sway of the target in a case where periodic change exists in the predetermined part of the target in the plurality of target images.

8. The information processing system according to claim 6, wherein the at least one processor is configured to execute the instructions to:
acquire the biometric information of the target whose movement sway changed by an output of the second guidance information, and
authenticate the target using the biometric information of the target whose movement sway changed.

9. The information processing system according to claim 6, wherein the at least one processor is configured to execute the instructions to:
output an alert information in addition to the second guidance information in a case where the movement sway of the target is not within a second predetermined range.

10. The information processing system according to claim 6, wherein
the movement sway of the target includes an information on a vertical direction change and a horizontal direction change of eyes position of the target, and
the at least one processor is configured to execute the instructions to:
output different second guidance information, in a case where the vertical direction change exceeds a vertical direction threshold, in a case where the horizontal direction change exceeds a horizontal direction threshold, and in a case where the vertical direction change exceeds the vertical direction threshold and the horizontal direction change exceeds the horizontal direction threshold, respectively.

11. The information processing system according to claim 6, wherein
the second guidance information is an object display information that displays an object so as to be visible to the target, and
the at least one processor is configured to execute the instructions to:
output the object display information so that the object moves depending on a direction and an amount of movement of the target.

12. The information processing system according to claim 6, wherein
the second guidance information is a video display information that displays a video so as to be visible to the target, and
the at least one processor is configured to execute the instructions to:
acquire a history information from a terminal held by the target, and output the video display information so as to display the video corresponding to the history information.

13. An information processing method that is executed by at least one computer, the information processing method comprising:
acquiring biometric information from a target moving in a predetermined area;
acquiring a movement speed of the target;
outputting a first guidance information for changing the movement speed of the target, based on the movement speed of the target; and
authenticating the target using the biometric information of the target.

14-16. (canceled)
